(19) United States
(12) Patent Application Publication
(10) Pub. No.: US 2016/0010692 A1
(43) Pub. Date: Jan. 14, 2016

(54) SEAL AND COVER

(71) Applicant: JTEKT CORPORATION, Osaka-shi, Osaka (JP)

(72) Inventor: Yuji YONEKURA, Nara-shi (JP)

(21) Appl. No.: 14/752,202

(22) Filed: Jun. 26, 2015

(30) Foreign Application Priority Data
Jul. 8, 2014 (JP) 2014-140748

(51) Int. Cl. F16C 33/78

(52) U.S. Cl. CPC F16C 33/7876; F16C 33/7896; F16C 33/7886

(57) ABSTRACT

A seal seals a bearing internal space in a bearing apparatus for a vehicle. The seal includes a core and a first elastic member attached to the core. The core includes a first tubular portion and a first flange portion. An outer peripheral surface of the first tubular portion is arranged so as to face an inner peripheral surface of an outer ring of the bearing apparatus. The first elastic member has a thick portion and a thin portion provided on the outer peripheral surface of the first tubular portion. The thick portion is arranged at an end of the first elastic member that is away from the bearing internal space in an axial direction of the bearing apparatus. The thin portion extends from the thick portion toward an end of the first elastic member that is opposite to the thick portion.

### INCORPORATION BY REFERENCE

The disclosure of Japanese Patent Application No. 2014-140748 filed on Jul. 8, 2014 including the specification, drawings and abstract, is incorporated herein by reference in its entirety.

### BACKGROUND OF THE INVENTION

1. Field of the Invention

The invention relates to a seal, and more specifically, to a seal for sealing a bearing internal space in a bearing apparatus for a vehicle. The present invention relates to a cover, and more specifically, to a cover for protecting a detection target member that is attached to the bearing apparatus in order to detect a vehicle wheel rotation speed.

2. Description of Related Art

A bearing apparatus with an outer ring, an inner ring, and a hub integrated together is conventionally known. The bearing apparatus is generally referred to as a hub unit. In the hub unit, a bearing internal space is formed between the outer ring, the inner ring, and the hub. A rolling element is arranged in the bearing internal space.

The bearing internal space in the hub unit is normally closed with a seal so as to prevent water from entering the bearing internal space. The seal includes a core and an elastic member. Such a seal is disclosed in, for example, Japanese Patent Application Publication No. 2009-127778 (JP 2009-12778 A) and Japanese Patent Application Publication No. 2009-162304 (JP 2009-162304 A).

In the seal in JP 2009-127778 A, the elastic member is bonded to the entire outer peripheral surface of the core. The elastic member is pressed against an inner peripheral surface of the outer ring by the pressure from the core.

Also in the seal in JP 2009-162304 A, the elastic member is bonded to the entire outer peripheral surface of the core. In the seal, the outer peripheral surface of the core includes a relief portion such as a taper portion or a through-hole. When the seal is pushed in between the outer ring, the inner ring, and the hub, a part of the elastic member is pushed out into the relief portion.

A detection mechanism is conventionally known which is used to detect a vehicle wheel rotation speed. In the detection mechanism, normally, a detection target member is fixed to the hub unit, and a rotation speed sensor is arranged to face the detection target member. The detection target member may be protected by a cover attached to the hub unit. Such a cover is disclosed in Japanese Patent Application Publication No. 2011-117549 (JP 2011-117549 A) and Japanese Patent Application Publication No. 2012-106547 (JP 2012-106547 A).

The covers in JP 2011-117549 A and JP 2012-106547 A each include a fitting portion, a reduced diameter portion, and a disc portion. The fitting portion is shaped like a cylinder and contacts an inner peripheral surface of the outer ring. The disc portion is arranged so as to face the detection target member and connected to the fitting portion via the reduced diameter portion. An annular protrusion formed of an elastic element is provided on a surface of the reduced diameter portion. The annular protrusion is pressed against the inner peripheral surface of the outer ring.

When the elastic member is provided on the entire outer peripheral surface of the core as is the case with the seals in JP 2009-127778 A and JP 2009-162304 A, the elastic member contacts the outer ring over a large area. This makes these seals more waterproof. However, the elastic member becomes large in volume, and thus, when the seal is attached to the hub unit, the elastic member is likely to spring back. Furthermore, the elastic member may deteriorate with the lapse of time to exhibit significantly reduced elasticity. Thus, in the above-described seals, the elastic member is likely to come away from the core.

On the other hand, in the covers in JP 2011-117549 A and JP 2012-106547 A, the annular protrusion is formed only in the reduced diameter portion. In these covers, the elastic member is not provided between the outer ring and the fitting portion. In such a configuration, keeping the cover sufficiently waterproof is difficult.

### SUMMARY OF THE INVENTION

An object of the present invention is to provide a seal and a cover that enable enhancement of both a waterproof property and performance of holding an elastic member.

A seal for sealing a bearing internal space in a bearing apparatus for a vehicle according to the present invention includes a core and a first elastic member. The core includes: a first tubular portion arranged such that an outer peripheral surface of the first tubular portion faces an inner peripheral surface of an outer ring of the bearing apparatus and extending along an axial direction of the bearing apparatus; and a first flange portion extending inward from the first tubular portion in a radial direction of the bearing apparatus. The first elastic member includes: a thick portion arranged on the outer peripheral surface of the first tubular portion at one of opposite ends, in the axial direction, of the first tubular portion that is away from a bearing internal space, the thick portion being provided along a circumferential direction of the first tubular portion; and a thin portion extending on the outer peripheral surface of the first tubular portion from the thick portion toward the other end of the first tubular portion in the axial direction and provided along a circumferential direction of the first tubular portion. An outer peripheral surface of the thick portion protrudes further outward than an outer peripheral surface of the thin portion in the radial direction. A thickness of the thin portion in the radial direction is smaller than a thickness of the thick portion in the radial direction.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a vertical sectional view depicting a general configuration of a bearing apparatus to which two seals according to a first embodiment are attached;

FIG. 2A is a partially enlarged view of FIG. 1;

FIG. 2B is a diagram depicting a vertical section of one of the seals according to the first embodiment;

FIG. 3A is a partially enlarged view of FIG. 1;

FIG. 3B is a diagram depicting a vertical section of the other seal according to the first embodiment;

FIG. 4 is a vertical sectional view depicting a general configuration of a part of a bearing apparatus to which a cover according to a second embodiment is attached;

FIG. 5A is a partially enlarged view of FIG. 4;

FIG. 5B is a vertical sectional view depicting a part of the cover according to the second embodiment; and

FIG. 6 is a diagram depicting a vertical section of a seal according to a modification of the first embodiment.

### DETAILED DESCRIPTION OF EMBODIMENTS

A seal according to an embodiment of the present invention seals a bearing internal space in a bearing apparatus for a vehicle. The seal includes a core and a first elastic member attached to the core. The core is arranged such that an outer peripheral surface of the core faces an inner peripheral surface of an outer ring of a bearing apparatus. The core includes a first tubular portion and a first flange portion. The first tubular portion extends along an axial direction of the bearing apparatus. The first flange portion extends inward from the first tubular portion in a radial direction of the bearing apparatus. The first elastic member is arranged on the outer peripheral surface of the first tubular portion at one of opposite ends, in the axial direction, of the first tubular portion that is away from the bearing internal space. The first elastic member includes a thick portion and a thin portion. The thick portion is provided along a circumferential direction of the first tubular portion. The thin portion extends on the outer peripheral surface of the first tubular portion from the thick portion toward the other end of the first tubular portion in the axial direction, and is provided along the circumferential direction of the first tubular portion. An outer peripheral surface of the thick portion protrudes further outward than an outer peripheral surface of the thin portion in the radial direction. A thickness of the thin portion in the radial direction is smaller than a thickness of the thick portion in the radial direction.

The first elastic member of the seal includes the thick portion and the thin portion. The thick portion and the thin portion are provided on the outer peripheral surface of the first tubular portion. The thin portion extends along the axial direction of the bearing apparatus. This configuration increases the length of the first elastic member in the axial direction to allow the first elastic member to contact the inner peripheral surface of the outer ring over a large area. Thus, the seal can be made more waterproof.

The thin portion is relatively thin in the radial direction of the bearing apparatus. Thus, even with an increase in the length of the first elastic member in the axial direction of the bearing apparatus, the volume of the first elastic member does not increase significantly. Consequently, the first elastic member can be hindered from springing back when the seal is attached to the bearing apparatus. Furthermore, the small volume of the first elastic member allows restraint of the elasticity of the first elastic member from decreasing significantly due to deterioration with the lapse of time. Therefore, the first elastic member is hindered from coming away from the first tubular portion, enabling an increase in performance of holding the first elastic member.

In the seal, the thickness of the thin portion in the radial direction may be 1/1 to 1/600 of the wall thickness of the first tubular portion.

The present configuration allows the thin portion of the first elastic member to be sufficiently thinned. Therefore, the performance of holding the first elastic member can further be improved. Furthermore, the sufficiently small thickness of the thin portion eliminates the need to reduce the wall thickness of the first tubular portion according to the thickness of the first elastic member. Therefore, a force of the first tubular portion that presses the first elastic member can be ensured. As a result, possible entrance of water into the bearing internal space can be more reliably prevented.

In the seal, the first elastic member covers the entire outer peripheral surface of the first tubular portion.

The present configuration allows a larger area to be secured where the first elastic member contacts the outer ring. Therefore, possible entrance of water into the bearing internal space is much more reliably prevented.

The seal may further include a slinger and a second elastic member attached to the slinger. The slinger is arranged such that an inner peripheral surface of the slinger faces an outer peripheral surface of an inner ring of the bearing apparatus. The slinger may include a second tubular portion and a second flange portion. The second tubular portion extends along the axial direction. The second flange portion extends outward from the second tubular portion in the radial direction. The second elastic member may be provided on an inner peripheral surface of the second tubular portion along a circumferential direction of the second tubular portion.

The present configuration allows prevention of possible entrance of water into the bearing internal space via a gap between the seal and the inner ring. Therefore, the seal can be made more waterproof.

In the seal, the second elastic member may cover the inner peripheral surface of the second tubular portion.

The present configuration allows the second elastic member to contact the outer peripheral surface of the inner ring over a large area. Therefore, the present configuration allows more reliable prevention of possible entrance of water into the bearing internal space via a gap between the seal and the inner ring.

In the seal, the thickness of the second elastic member in the radial direction may be 1/1 to 1/600 of the wall thickness of the second tubular portion.

The present configuration allows the second elastic member to be sufficiently thinned. Consequently, the second elastic member is hindered from springing back when the seal is attached to the bearing apparatus. Furthermore, the elasticity of the second elastic member is restrained from decreasing due to deterioration with the lapse of time. Thus, the second elastic member can be prevented from coming away from the second tubular portion.

The above-described configuration sufficiently reduces the thickness of the second elastic member, eliminating the need to reduce the wall thickness of the second tubular portion on which the second elastic member is provided. Therefore, a force of the second tubular portion that presses the second elastic member can be ensured. As a result, possible entrance of water into the bearing internal space can be more reliably prevented.

A cover according to the embodiment of the present invention protects a detection target member attached to the bearing apparatus in order to detect a vehicle wheel rotation speed. The cover includes a cover main body, a tubular portion, and an elastic member. The cover main body is arranged so as to cover the detection target member. The tubular portion is connected to the cover main body and arranged so as to extend along the axial direction of the bearing apparatus and such that an outer peripheral surface of the tubular portion faces the inner peripheral surface of the outer ring of the bearing apparatus. The elastic member is provided on the outer peripheral surface of the tubular portion along a circumferential direction of the tubular portion. The thickness of the elastic member in the radial direction of the bearing apparatus is ⅓ to 1/3,000 of the wall thickness of the tubular portion.

In the cover, the elastic member is arranged between the outer ring of the bearing apparatus and the outer peripheral surface of the tubular portion. Thus, possible entrance of water between the outer ring and the tubular portion can be prevented. The detection target member can be protected from water. In other words, the cover can be made more waterproof.

In the cover, the thickness of the elastic member in the radial direction of the bearing apparatus is ⅓ to 1/3,000 of the wall thickness of the tubular portion. That is, the thickness of the elastic member in the radial direction of the bearing apparatus is sufficiently small. Therefore, the elastic member is hindered from springing back when the cover is attached to the bearing apparatus. Furthermore, the elasticity of the elastic member is restrained from decreasing due to deterioration with the lapse of time. Thus, the elastic member is hindered from coming away from the tubular portion, enabling an increase in performance of holding the elastic member.

In the cover, the elastic member may cover the outer peripheral surface of the tubular portion.

With this configuration, the elastic member contacts the inner peripheral surface of the outer ring over a large area. This allows more reliable closure of the gap between the outer ring of the bearing apparatus and the outer peripheral surface of the tubular portion.

Embodiments of the present invention will be described with reference to the drawings. In the embodiments, identical or corresponding components are denoted by the same reference numerals, and the same description is not repeated.

A first embodiment of the present invention will be described.

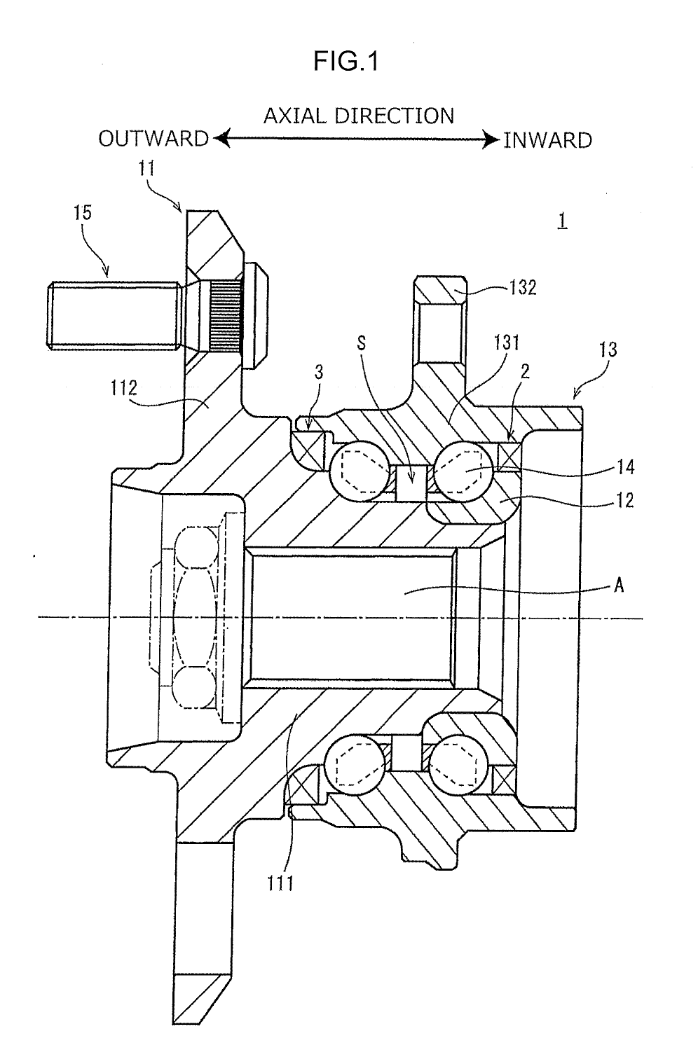

FIG. 1 is a vertical sectional view depicting a general configuration of a bearing apparatus 1 for a vehicle. In FIG. 1, seals 2 and 3 according to the first embodiment are attached to the bearing apparatus 1.

As depicted in FIG. 1, the bearing apparatus 1 includes a hub 11, an inner ring 12, an outer ring 13, and a plurality of rolling elements 14.

The hub 11 includes a generally cylindrical hub shaft 111 and a generally annular hub flange 112. An axle A is inserted into the hub 11. The hub shaft 111 and the axle A are fixed together. Thus, the hub 11 rotates with the axle A.

The hub flange 112 protrudes outward from an outer peripheral surface of the hub shaft 111 in a radial direction of the hub shaft 111. A disc wheel (not shown) and a brake disc (not shown) are fixed to the hub flange 112 using a plurality of fastening members 15.

The inner ring 12 is arranged at an end of the bearing apparatus 1 that is adjacent to a vehicle body in an axial direction of the bearing apparatus 1. Hereinafter, in the axial direction of the bearing apparatus 1, a direction toward the vehicle body is referred to as an inward direction and a direction away from the vehicle body is referred to as an outward direction. The inner ring 12 is shaped generally like a cylinder. A tip of the hub shaft 111 is inserted into the inner ring 12. The inner ring 12 is fixed to the outer peripheral surface of the hub shaft 111. Thus, the inner ring 12 rotates with the hub 11 and the axle A.

The outer ring 13 includes an outer ring main body 131 and an outer ring flange 132. The outer ring main body 131 is shaped generally like a cylinder. The hub shaft 111 and the inner ring 12 are inserted into the outer ring main body 131. The outer ring main body 131 is arranged concentrically with the hub shaft 111 and the inner ring 12.

The outer ring flange 132 protrudes outward from an outer peripheral surface of the outer ring main body 131 in a radial direction of the outer ring main body 131. The outer ring flange 132 is generally annular. For example, a knuckle (not shown) is fixed to the outer ring flange 132. In other words, the bearing apparatus 1 is supported by the vehicle body via a member such as the knuckle.

A generally cylindrical bearing internal space S is formed between an inner peripheral surface of the outer ring main body 131 and the outer peripheral surfaces of the hub shaft 111 and the inner ring 12. A plurality of rolling elements 14 is arranged in the bearing internal space S. The rolling elements 14 are aligned along a circumferential direction of the bearing internal space S. The bearing internal space S is internally filled with a lubricant.

As depicted in FIG. 1, the seals 2 and 3 seal the bearing internal space S. Each of the seals 2 and 3 is generally cylindrical. The seal 2 seals an inward end of the bearing internal space S in the axial direction of the bearing apparatus 1. The seal 3 seals an outward end of the bearing internal space S in the axial direction of the bearing apparatus 1.

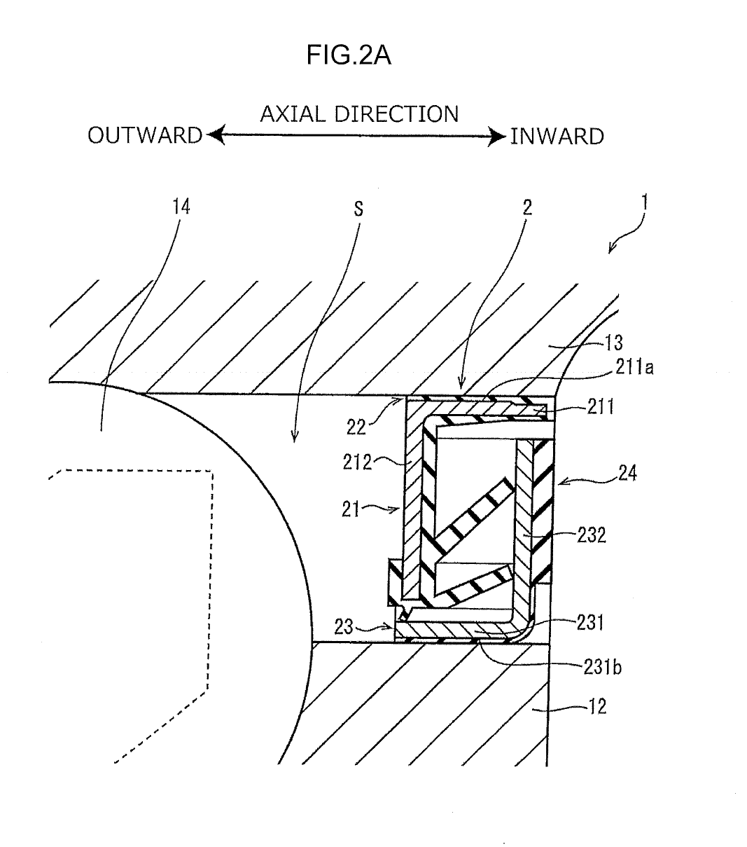

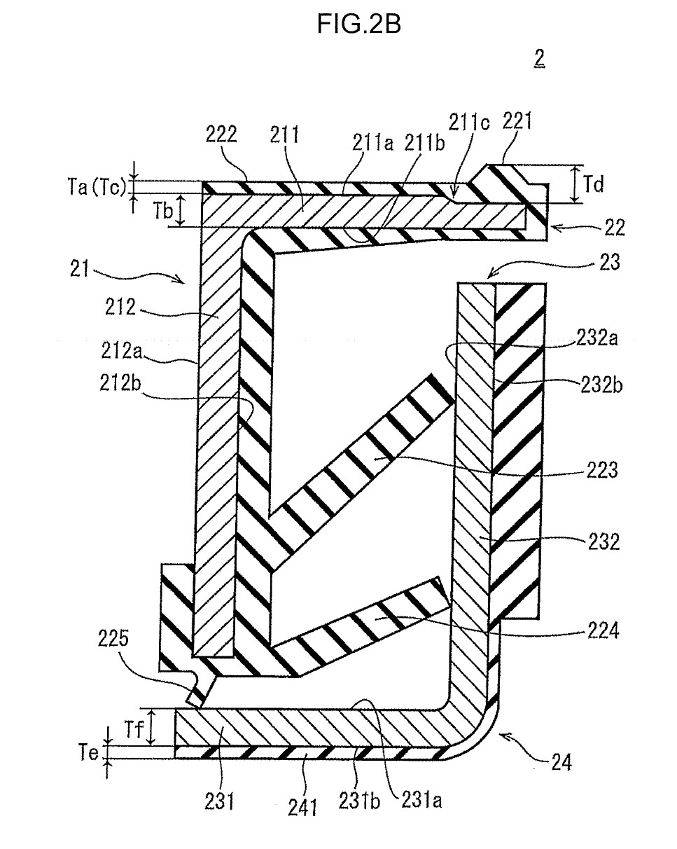

FIG. 2A is an enlarged view of a part of the bearing apparatus 1 to which the seal 2 is attached. FIG. 2B is a diagram depicting a section of the seal 2 as cut along a vertical plane passing through a center axis. As depicted in FIG. 2A and FIG. 2B, the seal 2 includes a core 21 and an elastic member 22. The seal 2 further includes a slinger 23 and an elastic member 24.

As depicted in FIG. 2B, the core 21 includes a tubular portion 211 and a flange portion 212. A material for the core 21 is not particularly limited and may be metal. For example, the core 21 may be formed of stainless steel.

The tubular portion 211 is shaped generally like a cylinder. The tubular portion 211 has an outer peripheral surface 211a and an inner peripheral surface 211b. As depicted in FIG. 2A, the tubular portion 211 is arranged concentrically with the bearing apparatus 1. When the seal 2 is attached to the bearing apparatus 1, the outer peripheral surface 211a of the tubular portion 211 faces an inner peripheral surface of the outer ring 13. A part of the elastic member 22 is interposed between the outer peripheral surface 211a of the tubular portion 211 and the inner peripheral surface of the outer ring 13. The tubular portion 211 extends along the axial direction of the bearing apparatus 1.

In the example in FIG. 2B, a step 211c is formed in the outer peripheral surface 211a of the tubular portion 211. Thus, the wall thickness of the tubular portion 211 is smaller near an open end of the tubular portion 211 than in the other parts of the first tubular portion 211. However, the formation of the step 211c in the outer peripheral surface 211a of the tubular portion 211 may be omitted.

The flange portion 212 is generally annular. As depicted in FIG. 2A, when the seal 2 is attached to the bearing apparatus 1, the flange portion 212 extends inward from the tubular portion 211 in the radial direction of the bearing apparatus 1.

The flange portion 212 is connected to the tubular portion 211. The flange portion 212 is arranged concentrically with the bearing apparatus 1. In the example in FIG. 2A, an end of the flange portion 212 in the radial direction of the bearing apparatus 1 is connected to an end of the tubular portion 211 in the axial direction of the bearing apparatus 1.

As depicted in FIG. 2B, the flange portion 212 has surfaces 212a and 212b. The surfaces 212a and 212b are contiguous with the outer peripheral surface 211a and inner peripheral surface 211b, respectively, of the tubular portion 211.

The elastic member 22 is attached to the core 21. The elastic member 22 is fixed to the core 21 so as not to come away from the core 21. The step 211c formed in the outer peripheral surface 211a of the tubular portion 211 hinders the first elastic member 22 from coming away from the core 21.

The elastic member 22 can be formed of an elastic material. A material for the elastic member 22 is not particularly limited but is preferably rubber, which is a high-elasticity material. Examples of the material for the elastic member 22 include: synthetic rubber such as nitrile rubber, silicone rubber, acrylic rubber, fluorine rubber, styrene butadiene rubber, or ethylene propylene rubber; natural rubber; or a combination thereof. When rubber is used as the material for the elastic member 22, the elastic member 22 may be fixed to the core 21, for example, by vulcanization bonding.

The elastic member 22 covers the entire outer peripheral surface 211a of the tubular portion 211. The elastic member 22 covers the entire open end and inner peripheral surface 211b of the tubular portion 211. The elastic member 22 covers the entire surface 212b of the flange portion 212. The elastic member 22 covers an open end of the flange portion 212 and a part of the surface 212a. In other words, the elastic member 22 extends along the outer peripheral surface 211a of the tubular portion 211, is then folded back at the open end, and then extends along the inner peripheral surface 211b. The elastic member 22 further extends along the surface 212b of the flange portion 212, is then folded back at the open end, and then extends to the middle of the surface 212a.

The elastic member 22 includes a thick portion 221 and a thin portion 222. The thick portion 221 is provided on the outer peripheral surface 211a of the tubular portion 211 along a circumferential direction of the tubular portion 211. The thick portion 221 is arranged on the open end of the tubular portion 211. In other words, the thick portion 221 is arranged on the outer peripheral surface 211a of the tubular portion 211 at an end of the tubular portion 211 that is away from the bearing internal space S.

As depicted in FIG. 2A, when the seal 2 is attached to the bearing apparatus 1, the thick portion 221 and the thin portion 222 are collapsed by the outer ring 13 and the tubular portion 211 of the core 21. However, as depicted in FIG. 2B, with the seal 2 not attached to the bearing apparatus 1, an outer peripheral surface of the thick portion 221 protrudes further outward than an outer peripheral surface of the thin portion 222 in a radial direction of the tubular portion 211. When the seal 2 is attached to the bearing apparatus 1, the axial direction and the radial direction of the tubular portion 211 coincide with the axial direction and the radial direction of the bearing apparatus 1.

The thin portion 222 extends on the outer peripheral surface 211a of the tubular portion 211 from the thick portion 221 toward an end of the tubular portion 211 opposite to the thick portion 221. In the example in FIG. 2B, the thin portion 222 reaches the end opposite to the thick portion 221. The thin portion 222 is provided on the outer peripheral surface 211a of the tubular portion 211 along the circumferential direction of the tubular portion 211.

With the seal 2 not attached to the bearing apparatus 1, the thickness of the thin portion 222 in the radial direction of the tubular portion 211 is smaller than the thickness of the thick portion 221 in the radial direction. The thin portion 222 is preferably sufficiently thin.

A smaller thickness of the thin portion 222 in the radial direction of the tubular portion 211 allows exertion of a force that fits the thin portion 222 on the core 21 (tubular portion 211) even when the elasticity of the thin portion 222 is lost as a result of deterioration with the lapse of time. Given the standard thickness of the core 21 (the standard wall thickness of the tubular portion 211) of approximately 0.6 mm and the manufacturable thickness of the thin portion 222, the thickness of the thin portion 222 in the radial direction of the tubular portion 211 may be 1 μm to 1,000 μm. Therefore, for example, with the seal 2 not attached to the bearing apparatus 1, the thickness Ta of the thin portion 222 in the radial direction of the tubular portion 211 is preferably 1/1 to 1/600 and more preferably ⅙ to 1/600 of the wall thickness Tb of the tubular portion 211. The thickness Ta of the thin portion 222 and the wall thickness Tb of the tubular portion 211 are the radial thicknesses of the thin portion 222 and the tubular portion 211, respectively, in a section of the seal 2 as cut along a plane perpendicular to the axial direction of the tubular portion 211.

Given that the thickness of the thin portion 222 in the radial direction of the tubular portion 211 may be 1 μm to 1,000 μm as described above and that the standard thickness of the thick portion 221 is approximately 0.6 mm, with the seal 2 not attached to the bearing apparatus 1, the thickness Tc of the thin portion 222 in the radial direction of the tubular portion 211 is preferably 1/1 to 1/600 and more preferably ⅙ to 1/600 of thickness Td of the thick portion 221 in the radial direction. The thickness Tc of the thin portion 222 and the thickness Td of the thick portion 221 are the thicknesses of parts of the thin portion 222 and the thick portion 221, respectively, where the outer peripheral surfaces of the thin portion 222 and the thick portion 221 are located most outward in the radial direction of the tubular portion 211. However, in the present embodiment, with the seal 2 not attached to the bearing apparatus 1, the thickness of the thin portion 222 in the radial direction of the tubular portion 211 is approximately constant over the entire thin portion 222.

The first elastic member 22 further includes seal lips 223, 224, and 225. The seal lips 223, 224, and 225 close a gap created between the core 21 and the slinger 23. In the example in FIG. 2B, the three seal lips 223, 224, and 225 are depicted. However, the number of seal lips of the elastic member 22 is not particularly limited.

The seal lips 223 and 224 protrude from the surface 212b of the flange portion 212 toward the tubular portion 211 and a flange portion 232 (described below) of the slinger 23. The seal lips 223 and 224 are provided along a circumferential direction of the flange portion 212 and are generally annular. Tips of the seal lips 223 and 224 are pressed against the slinger 23.

The seal lip 225 protrudes from the vicinity of the open end of the flange portion 212 toward a tubular portion 231 (described below) of the slinger 23. The seal lip 225 is provided along the circumferential direction of the flange portion 212 and is generally annular. A tip of the seal lip 225 is pressed against the slinger 23.

The slinger 23 includes a tubular portion 231 and a flange portion 232. A material for the slinger 23 is not particularly limited, and metal such as stainless steel may be used.

The tubular portion 231 is shaped generally like a cylinder. The tubular portion 231 has an outer peripheral surface 231a and an inner peripheral surface 231b. As depicted in FIG. 2A, the tubular portion 231 is arranged concentrically with the bearing apparatus 1. When the seal 2 is attached to the bearing apparatus 1, the inner peripheral surface 231b of the tubular portion 231 faces the outer peripheral surface of the inner ring 12. A part of the elastic member 24 is interposed between the inner peripheral surface 231b of the tubular portion 231 and the outer peripheral surface of the inner ring 12. The tubular portion 231 extends along the axial direction of the bearing apparatus 1.

As depicted in FIG. 2B, the outer peripheral surface 231a of the tubular portion 231 faces the open end of the flange portion 212 of the core 21. The tip of the seal lip 225 is pressed against the outer peripheral surface 231a of the tubular portion 231.

The flange portion 232 is generally annular. As depicted in FIG. 2A, when the seal 2 is attached to the bearing apparatus 1, the flange portion 232 extends outward from the tubular portion 231 in the radial direction of the bearing apparatus 1. The flange portion 232 is connected to the tubular portion 231. The flange portion 232 is arranged concentrically with the bearing apparatus 1. In the example in FIG. 2A, an end of the flange portion 232 in the radial direction of the bearing apparatus 1 is connected to an end of the tubular portion 231 in the axial direction of the bearing apparatus 1.

The flange portion 232 has surfaces 232a and 232b. The surfaces 232a and 232b are contiguous with the outer peripheral surface 231a and inner peripheral surface 231b, respectively, of the tubular portion 231.

The surface 232a of the flange portion 232 faces the surface 212b of the flange portion 212. The tips of the seal lips 223 and 224 are pressed against the surface 232a.

The elastic member 24 is attached to the slinger 23. The elastic member 24 is fixed to the slinger 23 so as not to come away from the slinger 23.

The elastic member 24 may be formed of an elastic material. A material similar to the material for the above-described elastic member 22 may be used for the elastic member 24. When rubber is used as a material for the elastic member 24, the elastic member 24 may be fixed to the slinger 23, for example, by vulcanization bonding.

The elastic member 24 covers the entire inner peripheral surface 231b of the tubular portion 231. The elastic member 24 covers the entire surface 232b of the flange portion 232.

A part of the elastic member 24 that is arranged on the inner peripheral surface 231b of the tubular portion 231 is preferably sufficiently thin in the radial direction of the tubular portion 231. This part is hereinafter referred to as a thin portion 241.

As is the case with the thin portion 222, a smaller thickness of the thin portion 241 in the radial direction of the tubular portion 231 allows exertion of a force that fits the thin portion 241 on the slinger 23 (tubular portion 231) even when the elasticity of the thin portion 241 is lost as a result of deterioration with the lapse of time. Given the standard thickness of the tubular portion 231 of approximately 0.6 mm and the manufacturable thickness of the thin portion 241, the thickness of the thin portion 241 in the radial direction of the tubular portion 231 may be 1 μM to 1,000 μm. Therefore, for example, with the seal 2 not attached to the bearing apparatus 1, the thickness Te of the thin portion 241 in the radial direction of the tubular portion 231 is preferably 1/1 to 1/600 and more preferably ⅙ to 1/600 of the wall thickness Tf of the tubular portion 231. The thickness Te of the thin portion 241 and the wall thickness Tf of the tubular portion 231 are the radial thicknesses of the thin portion 241 and the tubular portion 231, respectively, in a section of the seal 2 as cut along a plane perpendicular to the axial direction of the tubular portion 231. In the present embodiment, with the seal 2 not attached to the bearing apparatus 1, the thickness of the thin portion 241 in the radial direction of the tubular portion 231 is constant over the entire thin portion 241. When the seal 2 is attached to the bearing apparatus 1, the axial direction and the radial direction of the tubular portion 231 coincide with the axial direction and the radial direction of the bearing apparatus 1.

The thickness of a part of the elastic member 24 that is arranged on the surface 232b of the flange portion 212 may be determined as needed taking the easiness of manufacture into consideration. The thickness of this part may be equivalent to or larger than the thickness Te of the thin portion 241. In the example in FIG. 2B, a portion of the part of the elastic member 24 arranged on the surface 232b is equivalent to the thin portion 241 in thickness, and the remaining portion is thicker than the thin portion 241.

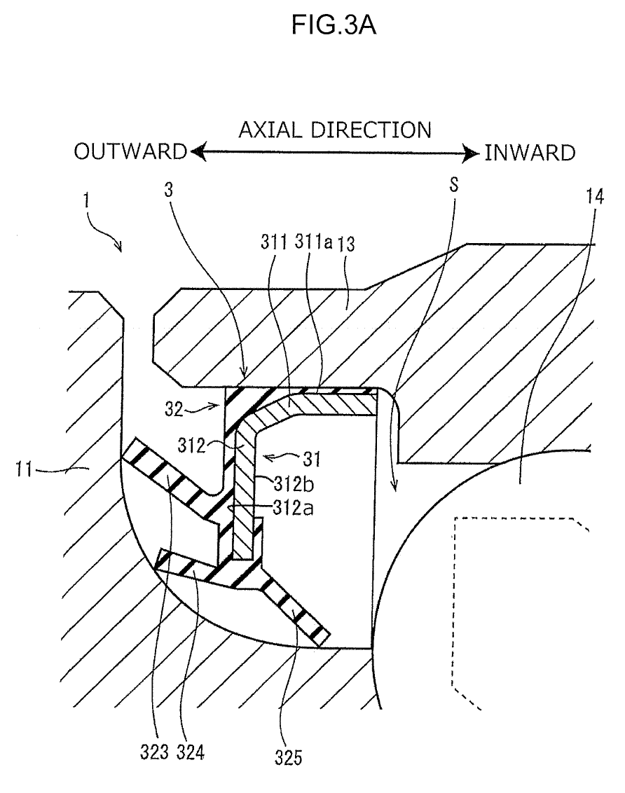

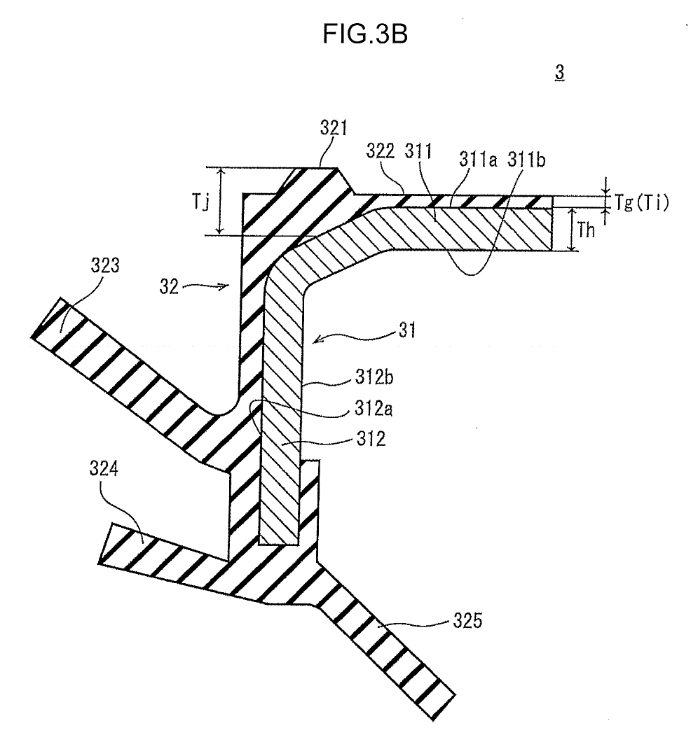

FIG. 3A is an enlarged view of a part of the bearing apparatus 1 to which the seal 3 is attached. FIG. 3B is a diagram depicting a section of the seal 3 as cut along a vertical plane passing through the center axis. As depicted in FIG. 3A and FIG. 3B, the seal 3 includes a core 31 and an elastic member 32.

As depicted in FIG. 3B, the core 21 includes a tubular portion 311 and a flange portion 312. As a material for the core 31, metal such as stainless steel, may be used as is the case with the core 21 of the seal 2.

The tubular portion 311 has an outer peripheral surface 311a and an inner peripheral surface 311b. As depicted in FIG. 3A, when the seal 3 is attached to the bearing apparatus 1, the outer peripheral surface 311a of the tubular portion 311 faces the inner peripheral surface of the outer ring 13. A part of the elastic member 32 is interposed between outer peripheral surface 311a of the tubular portion 311 and inner peripheral surface of the outer ring 13. The tubular portion 311 extends along the axial direction of the bearing apparatus 1.

As depicted in FIG. 3A, an end of the tubular portion 311 that is positioned outward in the axial direction of the bearing apparatus 1 when the seal 3 is attached to the bearing apparatus 1 is shaped like a tapered tube with a diameter increasing toward the bearing internal space S. The remaining part of the tubular portion 311 is shaped generally like a cylinder with an approximately constant diameter.

The flange portion 312 is generally annular. When the seal 3 is attached to the bearing apparatus 1, the flange portion 312 extends inward from the tubular portion 311 in the radial direction of the bearing apparatus 1. The flange portion 312 is connected to the tubular portion 311. In the example in FIG. 3A, an end of the flange portion 312 in the radial direction of the bearing apparatus 1 is connected to an end of the tubular portion 311 in the axial direction of the bearing apparatus 1.

As depicted in FIG. 3B, the flange portion 312 has surfaces 312a and 312b. The surfaces 312a and 312b are contiguous with the outer peripheral surface 311a and inner peripheral surface 311b, respectively, of the tubular portion 311.

The elastic member 32 is attached to the core 31. The elastic member 32 is fixed to the core 31 so as not to come away from the core 31.

The elastic member 32 may be formed of an elastic material. A material similar to the material for the above-described elastic member 22 of the seal 2 may be used for the elastic member 32. When rubber is used as a material for the elastic member 32, the elastic member 32 may be fixed to the core 31, for example, by vulcanization bonding.

The elastic member 32 covers the entire outer peripheral surface 311a of the tubular portion 311. The elastic member 32 covers the entire surface 312a of the flange portion 312. The elastic member 32 covers the open end of the flange portion 312 and a part of the surface 312b. In other words, the elastic member 32 extends along the outer peripheral surface 311a of the tubular portion 311 and the surface 312a of the flange portion 312, is then folded back at the open end of the flange portion 312, and extends to the middle of the surface 312b of the flange portion 312.

The elastic member 32 includes a thick portion 321 and a thin portion 322. The thick portion 321 is provided on the outer peripheral surface 311a of the tubular portion 311 along a circumferential direction of the tubular portion 311. The thick portion 321 is arranged at an end of the tubular portion 311 on a flange portion 312 side. In other words, the thick portion 321 is arranged on the outer peripheral surface 311a of the tubular portion 311 at an end of the tubular portion 311 that is away from the bearing internal space S.

As depicted in FIG. 3A, when the seal 3 is attached to the bearing apparatus 1, the thick portion 321 and the thin portion 322 are collapsed by the outer ring 13 and the tubular portion 311 of the core 31. However, as depicted in FIG. 3B, with the seal 3 not attached to the bearing apparatus 1, an outer peripheral surface of the thick portion 321 protrudes further outward than an outer peripheral surface of the thin portion 322 in a radial direction of the tubular portion 311. When the seal 3 is attached to the bearing apparatus 1, the axial direction and the radial direction of the tubular portion 311 coincide with the axial direction and the radial direction of the bearing apparatus 1.

The thin portion 322 extends on the outer peripheral surface 311a of the tubular portion 311 from the thick portion 321 toward an end of the tubular portion 311 opposite to the thick portion 321. In the example in FIG. 3B, the thin portion 322 reaches the open end of the tubular portion 311, that is, the end opposite to the thick portion 321. The thin portion 322 is provided on the outer peripheral surface 311a of the tubular portion 311 along the circumferential direction of the tubular portion 311.

With the seal 3 not attached to the bearing apparatus 1, the thickness of the thin portion 322 in the radial direction of the tubular portion 311 is smaller than the thickness of the thick portion 321 in the radial direction. The thin portion 322 is preferably sufficiently thin.

For example, with the seal 3 not attached to the bearing apparatus 1, the thickness Tg of the thin portion 322 in the radial direction of the tubular portion 311 is preferably 1/1 to 1/600 and more preferably ⅙ to 1/600 of the wall thickness Th of the tubular portion 311. The thickness Tg of the thin portion 322 and the wall thickness Th of the tubular portion 311 are the radial thicknesses of the thin portion 322 and the tubular portion 311, respectively, in a section of the seal 3 as cut along a plane perpendicular to the axial direction of the tubular portion 311.

For example, with the seal 3 not attached to the bearing apparatus 1, the thickness Ti of the thin portion 322 in the radial direction of the tubular portion 311 is preferably 1/1 to 1/600 and more preferably ⅙ to 1/600 of thickness Tj of the thick portion 321 in the radial direction. The thickness Ti of the thin portion 322 and the thickness Tj of the thick portion 321 are the thicknesses of parts of the thin portion 322 and the thick portion 321, respectively, where the outer peripheral surfaces of the thick portion 321 and the thin portion 322 are positioned most outward in the radial direction of the tubular portion 311. However, in the present embodiment, with the seal 3 not attached to the bearing apparatus 1, the thickness of the thin portion 322 in the radial direction of the tubular portion 311 is approximately constant over the entire thin portion 322.

The elastic member 32 further includes seal lips 323, 324, and 325. The seal lips 323, 324, and 325 close a gap created between the core 31 and the hub 11. In the example in FIG. 3A, the three seal lips 323, 324, and 325 are depicted. However, the number of seal lips of the elastic member 32 is not particularly limited.

As depicted in FIG. 3A, the seal lips 323 and 324 protrude outward from the surface 312a of the flange portion 312 in the axial direction and the radial direction of the bearing apparatus 1. The seal lips 323 and 324 are provided along a circumferential direction of the flange portion 312 and are generally annular. Tips of the seal lips 323 and 324 are pressed against the hub 11.

The seal lip 325 protrudes inward from the vicinity of the open end of the flange portion 312 in the axial direction and the radial direction of the bearing apparatus 1. The seal lip 325 is provided along the circumferential direction of the flange portion 312 and is generally annular. A tip of the seal lip 325 is pressed against the hub 11.

The elastic member 22 of the seal 2 according to the first embodiment has the thick portion 221 and the thin portion 222. The elastic member 32 of the seal 3 has the thick portion 321 and the thin portion 322. The thin portions 222 and 322 extend along the axial direction of the bearing apparatus 1 between the core 21 and the outer ring 13 and between the core 31 and the outer ring 13, respectively. Consequently, a sufficient area is secured in which the elastic members 22 and 32 contact the outer ring 13. Thus, possible entrance of water into the bearing internal space S can be prevented.

In the elastic members 22 and 32, the thin portions 222 and 322 are relatively thin in the radial direction of the bearing apparatus 1. For example, the thickness Ta of the thin portion 222 is, for example, 1/1 to 1/600 of the wall thickness Tb of the tubular portion 211. The thickness Tg of the thin portion 322 is, for example, 1/1 to 1/600 of the wall thickness Th of the tubular portion 311. Thus, the elastic members 22 and 32 have small volumes. Consequently, when the seals 2 and 3 are attached to the bearing apparatus 1, the elastic members 22 and 32 are less likely to spring back. Furthermore, the elasticity of the elastic members 22 and 32 can be restrained from decreasing significantly due to deterioration with the lapse of time. Therefore, the elastic members 22 and 32 are less likely to come away from the cores 21 and 31, respectively, enabling an increase in performance of holding the elastic members 22 and 32.

In the seals 2 and 3, the thin portions 222 and 322 are sufficiently thin, eliminating the need to reduce the wall thicknesses of the tubular portions 211 and 311 of the cores 21 and 31, respectively. Therefore, the tubular portions 211 and 311 allow the elastic members 22 and 32 to be firmly pressed against the outer ring 13. As a result, possible entrance of water into the bearing internal space S is reliably prevented.

The elastic members 22 and 32 of the seals 2 and 3 cover the entire outer peripheral surfaces 211a and 311a of the tubular portions 211 and 311, respectively. Thus, larger areas can be secured where the elastic members 22 and 32 contact the outer ring 13. Therefore, possible entrance of water into the bearing internal space S is more reliably prevented.

In the seal 2, the elastic member 24 is provided on the inner peripheral surface 231b of the tubular portion 231 of the slinger 23. The elastic member 24 is pressed against the inner ring 12 by the slinger 23. This allows more reliable closure of the gap between the slinger 23 and the inner ring 12. As a result, the seal 2 allows prevention of possible entrance of water into the bearing internal space S via a gap between the slinger 23 and the inner ring 12.

In the seal 2, the elastic member 24 covers the entire inner peripheral surface 231b of the tubular portion 231. Thus, a large area can be secured where the elastic member 24 contacts the inner ring 12. Therefore, the seal 2 allows prevention of possible entrance of water into the bearing internal space S via the gap between the slinger 23 and the inner ring 12.

In the seal 2, the elastic member 24 is relatively thin in the radial direction of the bearing apparatus 1. For example, the thickness Te of the elastic member 24 is 1/1 to 1/600 of the wall thickness Tf of the tubular portion 231. Consequently, after the seal 2 is attached to the bearing apparatus 1, the elastic member 24 is less likely to spring back. Furthermore, the elasticity of the elastic member 24 can be restrained from decreasing due to deterioration with the lapse of time. Therefore, the elastic member 24 can be prevented from coming away from the slinger 23.

A second embodiment of the present invention will be described below.

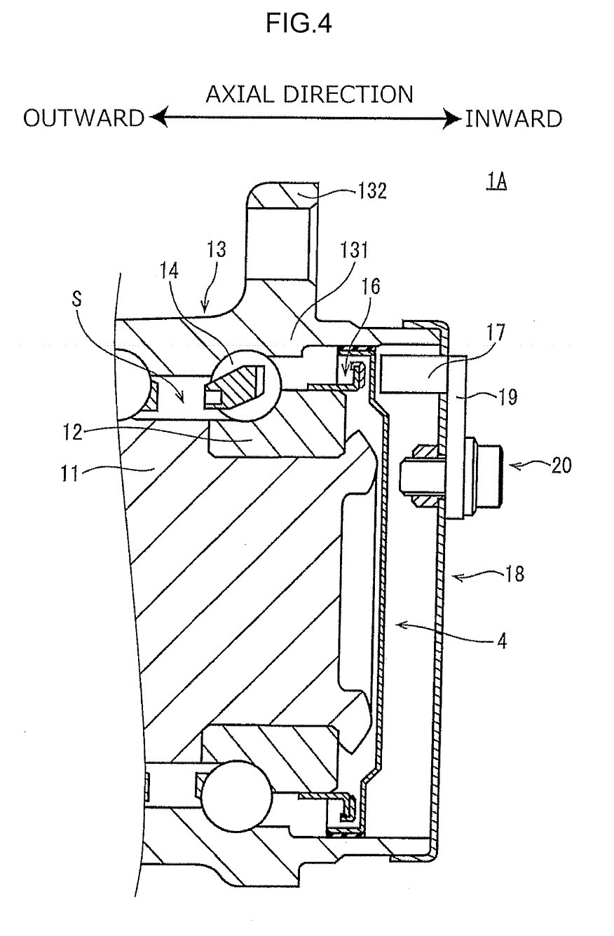

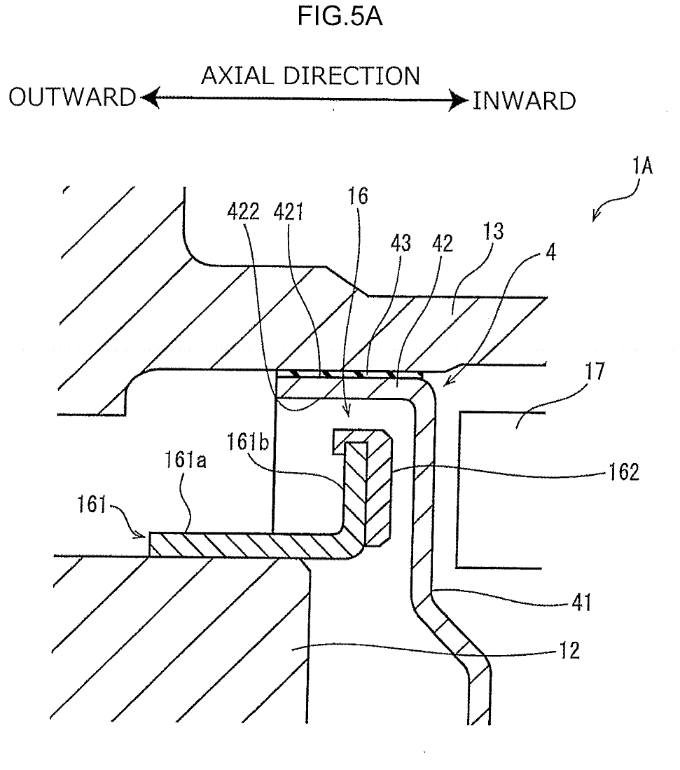

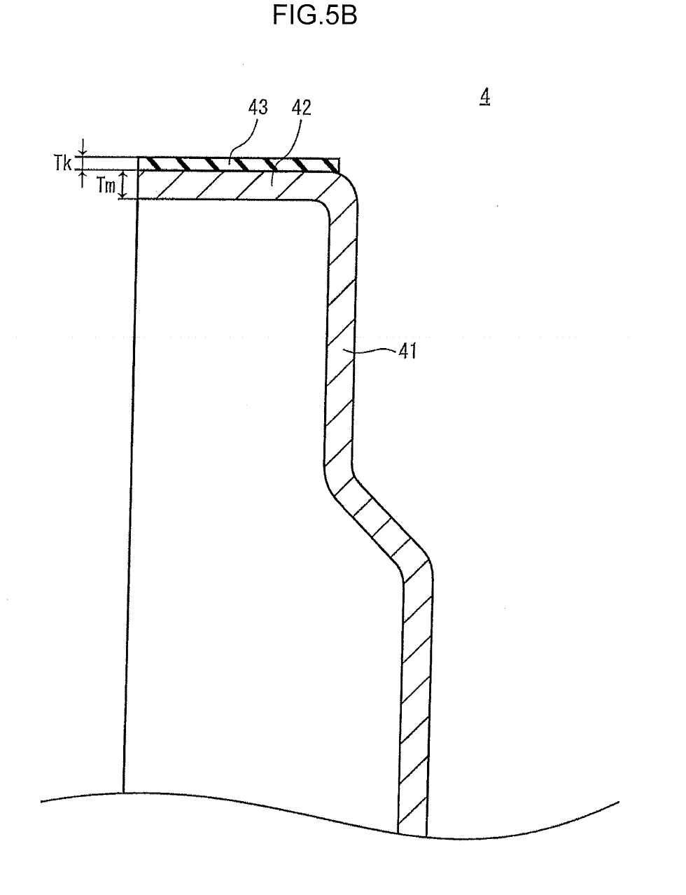

FIG. 4 is a vertical sectional view depicting a general configuration of a part of a bearing apparatus 1A for a vehicle. In FIG. 4, a cover 4 according to a second embodiment is attached to the bearing apparatus 1A. FIG. 5A is an enlarged view of a part of the bearing apparatus 1A to which the cover 4 is attached.

The bearing apparatus 1A is different from the bearing apparatus 1 according to the first embodiment in that the bearing apparatus 1A has a detection mechanism for the rotation speed of vehicle wheels. Members for detecting the rotation speed will be described below. The other members are denoted by the same reference numerals as those in the first embodiment and will not be described below.

As depicted in FIG. 4, the bearing apparatus 1A includes a pulsar ring 16, a rotation speed sensor 17, and a cap 18.

As depicted in FIG. 5A, the pulsar ring 16 includes a support ring 161 and a detection target member 162. The support ring 161 includes a main body portion 161a and flange portion 161b. The main body portion 161a is cylindrical. The flange portion 161b extends outward from one end of the main body portion 161a in a radial direction of the bearing apparatus 1A.

The pulsar ring 16 is installed on an inner ring 12. Specifically, the inner ring 12 is fitted in the main body portion 161a.

The detection target member 162 is attached to a surface of the flange portion 161b on an inward side in an axial direction of the bearing apparatus 1A. Thus, the detection target member 162 rotates with the inner ring 12. The detection target member 162 is generally annular. The detection target member 162 is magnetized such that N poles and S poles are alternately arranged along a circumferential direction of the detection target member 162.

The rotation speed sensor 17 detects the rotation speed of the vehicle wheels based on a change in magnetic flux caused by rotation of the detection target member 162. The rotation speed sensor 17 faces the detection target member 162. However, a cover 4 is arranged between the detection target member 162 and the rotation speed sensor 17.

As depicted in FIG. 4, the cap 18 closes an inward end of the outer ring 13 in the axial direction of the bearing apparatus 1A. A rotation speed sensor 17 is attached to the cap 18. Specifically, the rotation speed sensor 17 is inserted into a through-hole formed in the cap 18. The rotation speed sensor 17 is fixed to the cap 18 using a support member 19 and a fastening member 20.

As depicted in FIG. 5A, the cover 4 is attached to the bearing apparatus 1A to protect the detection target member 162. The cover 4 is pushed into the outer ring 13. The cover 4 is formed of a material that does not affect the sensitivity of the rotation speed sensor 17. The cover 4 may be formed of nonmagnetic steel such as austenite stainless steel.

The cover 4 includes a cover main body 41, a tubular portion 42, and an elastic member 43.

The cover main body 41 is shaped generally like a disc. The cover main body 41 is arranged between the detection target member 162 and the rotation speed sensor 17 so as to be substantially perpendicular to the axial direction of the bearing apparatus 1A. That is, the cover main body 41 covers the detection target member 162 from inward in the axial direction of the bearing apparatus 1A.

In the present embodiment, a central portion of the cover main body 41 protrudes further inward along the axial direction of the bearing apparatus 1A than a peripheral portion of the cover main body 41. However, the shape of the cover main body 41 is not limited to this. For example, the cover main body 41 may be shaped like a disc that is flat over the entire surface thereof.

The tubular portion 42 is generally cylindrical. The tubular portion 42 has an outer peripheral surface 421 and an inner peripheral surface 422. When the cover 4 is attached to the bearing apparatus 1A, the outer peripheral surface 421 of the tubular portion 42 faces an inner peripheral surface of the outer ring 13. The elastic member 43 is interposed between the outer peripheral surface 421 of the tubular portion 42 and the inner peripheral surface of the outer ring 13. The tubular portion 42 extends along the axial direction of the bearing apparatus 1A. An inward end of the tubular portion 42 in the axial direction of the bearing apparatus 1A is connected to a peripheral edge of the cover main body 41.

The elastic member 43 is provided on the outer peripheral surface 421 of the tubular portion 42 along a circumferential direction of the tubular portion 42. The elastic member 43 covers the entire outer peripheral surface 421.

FIG. 5B is a vertical sectional view depicting a part of the cover 4 not attached to the bearing apparatus 1A. When the cover 4 is attached to the bearing apparatus 1A, the elastic member 43 is collapsed by the outer ring 13 and the tubular portion 42.

With the cover 4 not attached to the bearing apparatus 1A, the thickness of the elastic member 43 in the radial direction of the tubular portion 42 is preferably sufficiently small. Given the standard wall thickness of the tubular portion 42 of approximately 1 mm to 3 mm and the manufacturable thickness of the elastic member 43, the thickness Tk of the elastic member 43 may be 1 μm to 1,000 μm. Thus, as seen in FIG. 5B, for example, the thickness Tk of the elastic member 43 in the radial direction of the tubular portion 42 is ⅓ to 1/3,000 and preferably 1/30 to 1/3,000 of the wall thickness Tm of the tubular portion 42. The thickness Tk of the elastic member 43 and the thickness Tm of the tubular portion 42 are the radial thicknesses of the elastic member 43 and the tubular portion 42 in a section of the cover 4 as cut along a plane perpendicular to the axial direction of the tubular portion 42. In the present embodiment, with the cover 4 not attached to the bearing apparatus 1A, the thickness of the elastic member 43 in the radial direction of the tubular portion 42 is approximately constant over the entire elastic member 43. When the cover 4 is attached to the bearing apparatus 1A, the axial direction and the radial direction of the tubular portion 42 coincide with axial direction and the radial direction of the bearing apparatus 1A.

In the cover 4 according to the second embodiment, the elastic member 43 is arranged between the tubular portion 42 and the outer ring 13. Thus, possible entrance of water between the cover 4 and the outer ring 13 can be reliably prevented. Therefore, the cover 4 allows the detection target member 162 to be protected from water.

In the cover 4, the thickness Tk of the elastic member 43 is ⅓ to 1/3,000 of the wall thickness Tm of the tubular portion 42. In other words, the elastic member 43 is sufficiently thin. Thus, when the cover 4 is attached to the bearing apparatus 1A, the elastic member 43 is less likely to spring back. Furthermore, the elasticity of the elastic member 43 can be restrained from decreasing significantly due to deterioration with the lapse of time. As a result, the elastic member 43 is less likely to come away from the tubular portion 42, enabling an increase in performance of holding the elastic member 43.

The elastic member 43 covers the entire outer peripheral surface 421 of the tubular portion 42. Thus, a large area can be secured where the elastic member 43 contacts the outer ring 13. This allows more reliable closure of the gap between the outer ring 13 and the cover 4.

The embodiments of the present invention have been described. However, the present invention is not limited to the above-described embodiments, and various changes may be made to the embodiments without departing from the scope of the present invention.

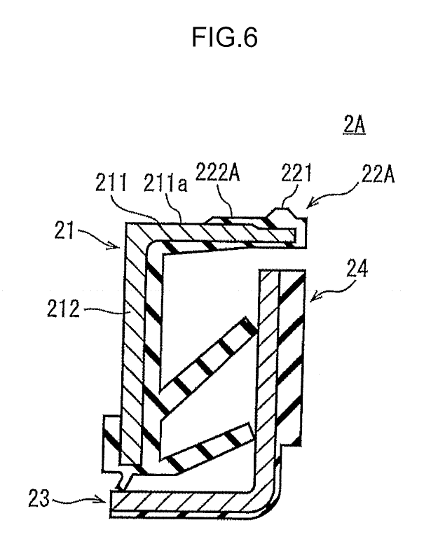

In the first embodiment, the elastic member 22 of the seal 2 covers the entire outer peripheral surface 211a of the tubular portion 211. However, the present invention is not limited to this. As depicted in FIG. 6, an elastic member 22A of a seal 2A may cover a part of the outer peripheral surface 211a of the tubular portion 211. That is, on the outer peripheral surface 211a of the tubular portion 211, a thin portion 222A need not reach the end of the tubular portion 211 opposite to the thick portion 221.

Likewise, the elastic member 24 of the seal 2 need not cover the entire inner peripheral surface 231b of the slinger 23. The elastic member 32 of the seal 3 need not cover the entire outer peripheral surface 311a of the tubular portion 311. Also for the cover 4 according to the second embodiment, the elastic member 43 need not cover the entire outer peripheral surface 421 of the tubular portion 42.

In the first embodiment, with the seals 2 and 3 not attached to the bearing apparatus 1, the thicknesses of the thin portions 222 and 322 in the radial direction of the bearing apparatus 1 are approximately constant over the entire thin portions 222 and 322. However, the thickness of each of the thin portions 222 and 322 in the radial direction of the bearing apparatus 1 may vary along the axial direction of the bearing apparatus 1. However, the maximum thicknesses of the thin portions 222 and 322 in the radial direction of the bearing apparatus 1 are preferably 1/1 to 1/600 of the wall thicknesses of the tubular portions 211 and 311, respectively.

In the first embodiment, with the seal 2 not attached to the bearing apparatus 1, the thickness of the elastic member 24 in the radial direction of the bearing apparatus 1 is approximately constant over the entire elastic member 24. However, the thickness of the elastic member 24 in the radial direction of the bearing apparatus 1 may vary along the axial direction of the bearing apparatus 1. However, the maximum thickness of the elastic member 24 in the radial direction of the bearing apparatus 1 is preferably 1/1 to 1/600 of the wall thickness of the tubular portion 231.

In the seal 2 according to the first embodiment, the elastic member 24 is provided on the slinger 23. However, the elastic member 24 may be omitted from the slinger 23.

In the first embodiment, the seals 2 and 3 are attached to the bearing apparatus 1. However, instead of one of the seals 2 and 3, a well-known seal may be attached to the bearing apparatus 1.

In the cover 4 in the second embodiment, the elastic member 43 is provided only on the outer peripheral surface 421 of the tubular portion 42. However, the elastic member 43 may extend onto the surface of the cover main body 41.

In the second embodiment, with the cover 4 not attached to the bearing apparatus 1A, the thickness of the elastic member 43 in the radial direction of the bearing apparatus 1A is substantially constant over the entire elastic member 43. However, the thickness of the elastic member 43 in the radial direction of the bearing apparatus 1A may vary along the axial direction of the bearing apparatus 1A. However, the maximum thickness of the elastic member 43 in the radial direction of the bearing apparatus 1A is preferably ⅓ to 1/3,000 of the wall thickness of the tubular portion 42.

The seal and cover according to the present invention allows enhancement of both the waterproof property and performance of holding the elastic member.

What is claimed is:

1. A seal for sealing a bearing internal space in a bearing apparatus for a vehicle, the seal comprising:
a core; and
a first elastic member, wherein
the core includes:
a first tubular portion arranged such that an outer peripheral surface of the first tubular portion faces an inner peripheral surface of an outer ring of the bearing apparatus and extending along an axial direction of the bearing apparatus; and
a first flange portion extending inward from the first tubular portion in a radial direction of the bearing apparatus,
the first elastic member includes:
a thick portion arranged on the outer peripheral surface of the first tubular portion at one of opposite ends, in the axial direction, of the first tubular portion that is away from a bearing internal space, the thick portion being provided along a circumferential direction of the first tubular portion, and
a thin portion extending on the outer peripheral surface of the first tubular portion from the thick portion toward the other end of the first tubular portion in the axial direction and provided along the circumferential direction of the first tubular portion, and
an outer peripheral surface of the thick portion protrudes further outward than an outer peripheral surface of the thin portion in the radial direction, and a thickness of the thin portion in the radial direction is smaller than a thickness of the thick portion in the radial direction.

2. The seal according to claim 1, wherein
the thickness of the thin portion in the radial direction is 1/1 to 1/600 of a wall thickness of the first tubular portion.

3. The seal according to claim 1, wherein
the first elastic member covers the entire outer peripheral surface of the first tubular portion.

4. The seal according to claim 2, wherein
the first elastic member covers the entire outer peripheral surface of the first tubular portion.

5. The seal according to claim 1, further comprising:
a slinger; and
a second elastic member attached to the slinger, wherein
the slinger includes:
a second tubular portion arranged such that an inner peripheral surface of the second tubular portion faces an outer peripheral surface of an inner ring of the bearing apparatus and extending along the axial direction; and
a second flange portion extending outward from the second tubular portion in the radial direction, and
the second elastic member is provided on the inner peripheral surface of the second tubular portion along a circumferential direction of the second tubular portion.

6. The seal according to claim 2, further comprising:
a slinger; and
a second elastic member attached to the slinger, wherein
the slinger includes:
a second tubular portion arranged such that an inner peripheral surface of the second tubular portion faces an outer peripheral surface of an inner ring of the bearing apparatus and extending along the axial direction; and
a second flange portion extending outward from the second tubular portion in the radial direction, and
the second elastic member is provided on the inner peripheral surface of the second tubular portion along a circumferential direction of the second tubular portion.

7. The seal according to claim 3, further comprising:
a slinger; and
a second elastic member attached to the slinger, wherein
the slinger includes:
a second tubular portion arranged such that an inner peripheral surface of the second tubular portion faces an outer peripheral surface of an inner ring of the bearing apparatus and extending along the axial direction; and
a second flange portion extending outward from the second tubular portion in the radial direction, and
the second elastic member is provided on the inner peripheral surface of the second tubular portion along a circumferential direction of the second tubular portion.

8. The seal according to claim 4, further comprising:
a slinger; and
a second elastic member attached to the slinger, wherein
the slinger includes:
a second tubular portion arranged such that an inner peripheral surface of the second tubular portion faces an outer peripheral surface of an inner ring of the bearing apparatus and extending along the axial direction; and
a second flange portion extending outward from the second tubular portion in the radial direction, and
the second elastic member is provided on the inner peripheral surface of the second tubular portion along a circumferential direction of the second tubular portion.

9. The seal according to claim 5, wherein
the second elastic member covers the entire inner peripheral surface of the second tubular portion.

10. The seal according to claim 6, wherein
the second elastic member covers the entire inner peripheral surface of the second tubular portion.

11. The seal according to claim 7, wherein
the second elastic member covers the entire inner peripheral surface of the second tubular portion.

12. The seal according to claim 8, wherein
the second elastic member covers the entire inner peripheral surface of the second tubular portion.

13. The seal according to claim 5, wherein
a thickness of the second elastic member in the radial direction is 1/1 to 1/600 of a wall thickness of the second tubular portion.

14. The seal according to claim 6, wherein
a thickness of the second elastic member in the radial direction is 1/1 to 1/600 of a wall thickness of the second tubular portion.

15. The seal according to claim 7, wherein
a thickness of the second elastic member in the radial direction is 1/1 to 1/600 of a wall thickness of the second tubular portion.

16. The seal according to claim 9, wherein
a thickness of the second elastic member in the radial direction is 1/1 to 1/600 of a wall thickness of the second tubular portion.

17. The seal according to claim 10, wherein
a thickness of the second elastic member in the radial direction is 1/1 to 1/600 of a wall thickness of the second tubular portion.

18. The seal according to claim 11, wherein
a thickness of the second elastic member in the radial direction is 1/1 to 1/600 of a wall thickness of the second tubular portion.

19. A cover for protecting a detection target member attached to a bearing apparatus in order to detect a vehicle wheel rotation speed, the cover comprising:
a cover main body arranged so as to cover the detection target member;
a tubular portion connected to the cover main body, extending along an axial direction of the bearing apparatus, and arranged such that an outer peripheral surface of the tubular portion faces an inner peripheral surface of an outer ring of the bearing apparatus; and
an elastic member provided on the outer peripheral surface of the tubular portion along a circumferential direction of the tubular portion, wherein
a thickness of the elastic member in a radial direction of the bearing apparatus is ⅓ to 1/3,000 of a wall thickness of the tubular portion.

20. The cover according to claim 19, wherein
the elastic member covers the entire outer peripheral surface of the tubular portion.
